(19) United States
(12) Patent Application Publication
(10) Pub. No.: US 2004/0046439 A1
(43) Pub. Date: Mar. 11, 2004

(54) Compound wheel

(76) Inventor: Essam T. Awdalla, Alexandria (EG)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 10/237,647

(22) Filed: Sep. 9, 2002

(51) Int. Cl. B60B 1/00

(52) U.S. Cl. 301/5.1

(57) ABSTRACT

The present invention provides a compound wheel comprising an inner wheel member confined within an outer wheel member. The inner wheel member has a hub, a central part, and an inner rim, and the outer wheel member has an outer rim, with means for preventing lateral displacement of the inner rim and the outer rim relative to one another. In an embodiment, a lubricant is provided in the space confined between the opposing surfaces of the inner rim and the outer rim. Means may be provided for preventing relative slipping of the outer surface of the inner rim and the inner surface of the outer rim relative to one another.

### FIELD OF THE INVENTION

The present invention provides a wheel for use in wheeled conveyances such as land vehicles, industrial carts and the like, and more particularly a compound wheel which requires a decreased amount of force for overcoming resistance due to friction during operation.

### DESCRIPTION OF PRIOR ART

Wheels are well known machine elements, e.g., used in land vehicles and the like, to facilitate smoother movement on planar surfaces. The main components of a conventional wheel are a wheel hub through which the wheel is attached to the axle means around which it rotates; a cylindrical rim in contact with the planar surface on which the wheel rotates, either directly or through tires; and a central section connecting the hub to the cylindrical rim.

The frictional forces existing between the surfaces in relative motion when a wheel rolls on a planar surface are referred to as forces of rolling friction, the magnitude of which depends mainly on the materials of the opposing surfaces of the wheel and the plane as well as the load being supported via the wheel. For each application, the material of the outer contact surface of the wheel is chosen so that sufficient forces of rolling friction are present to prevent or minimize slipping between the wheel and the planar surface on which it rolls during operation.

It is desirable to decrease the forces of rolling friction as much as possible to minimize the fraction of mechanical energy dissipated in overcoming it. However, this is hindered by the practical need for good contact between the opposing surfaces of the wheel and the planar surface on which it is rolling.

It has been known in the art to use internal gear arrangements such as depicted in FIG. 1 in order to transfer rotary power in machines. However, it is not believed that such an arrangement has been used in a compound wheel for a wheeled conveyance as described and claimed herein.

### SUMMARY OF THE INVENTION

An object of the present invention is to provide a compound wheel in which the energy expended in overcoming the resistance due to friction is decreased, while maintaining adequate contact between the wheel and the planar surface on which it rolls during operation.

Also, it is an object of the present invention to provide such a wheel which is simple to implement, and can be used in all types of wheeled conveyances, e.g., automobiles, trucks, rail cars, and other types of wheeled carts and carriers.

In accordance with the present invention, the compound wheel comprises two wheel members, a first driving wheel member and a second driven wheel member. The first wheel member is confined within the perimeter of the second wheel member and has a hub providing attachment to an axle, a central part, and an inner rim. The second wheel member has a second rim that is the outer rim of the compound wheel and structure preventing lateral displacement of the inner rim and the outer rim relative to one another.

The material(s) used in the manufacture of the contacting opposing surfaces of the inner rim and outer rim is chosen so that minimal operational frictional forces are created between the opposing surfaces of the two rims. In an embodiment, a lubricant may be optionally provided in the space confined between the opposing surfaces of the two rims to further minimize the friction between their opposing contacting surfaces.

In an embodiment, the compound wheel further comprises structure for preventing slipping of the opposing surfaces of the inner and outer rims relative to one another during operation.

### BRIEF DESCRIPTION OF THE DRAWINGS

Having thus described the invention in general terms, reference will now be made to the accompanying drawings, which are not necessarily drawn to scale, and wherein:

FIG. 1 is a depiction of a prior art interior gear.

FIG. 2 is a simplified schematic representation of the compound wheel provided in the present invention, showing its kinematics during acceleration.

FIG. 3 is a simplified schematic representation of the compound wheel provided in the present invention, showing its kinematics during deceleration.

FIG. 4 is a cross sectional view of a schematic representation of an exemplary embodiment of a compound wheel in accordance with the present invention.

FIG. 4A is a cross sectional view, taken at the plane of line 4A-4A in FIG. 4.

FIG. 4B is a generally cross sectional view, taken at the plane of line 4B-4B in FIG. 4.

FIG. 5 is a generally cross sectional view of a schematic representation of an exemplary embodiment of another compound wheel in accordance with the present invention.

FIG. 6 is a cross sectional view, taken at the plane of line 6-6 in FIG. 5.

FIG. 7 is a generally cross sectional view of a schematic representation of an exemplary embodiment of another compound wheel in accordance with the present invention.

FIG. 8 is a cross sectional view, taken at the plane of line 8-8 in FIG. 7.

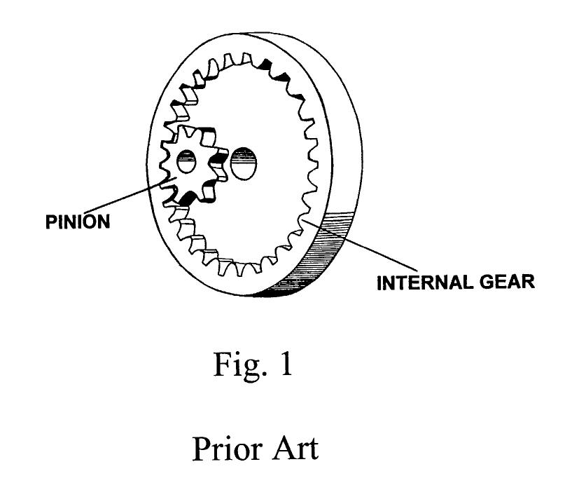

### DETAILED DESCRIPTION

The present inventions now will be described more fully hereinafter with reference to the accompanying drawings, in which some, but not all embodiments of the invention are shown. Indeed, these inventions may be embodied in many different forms and should not be construed as limited to the embodiments set forth herein; rather, these embodiments are provided so that this disclosure will satisfy applicable legal requirements.

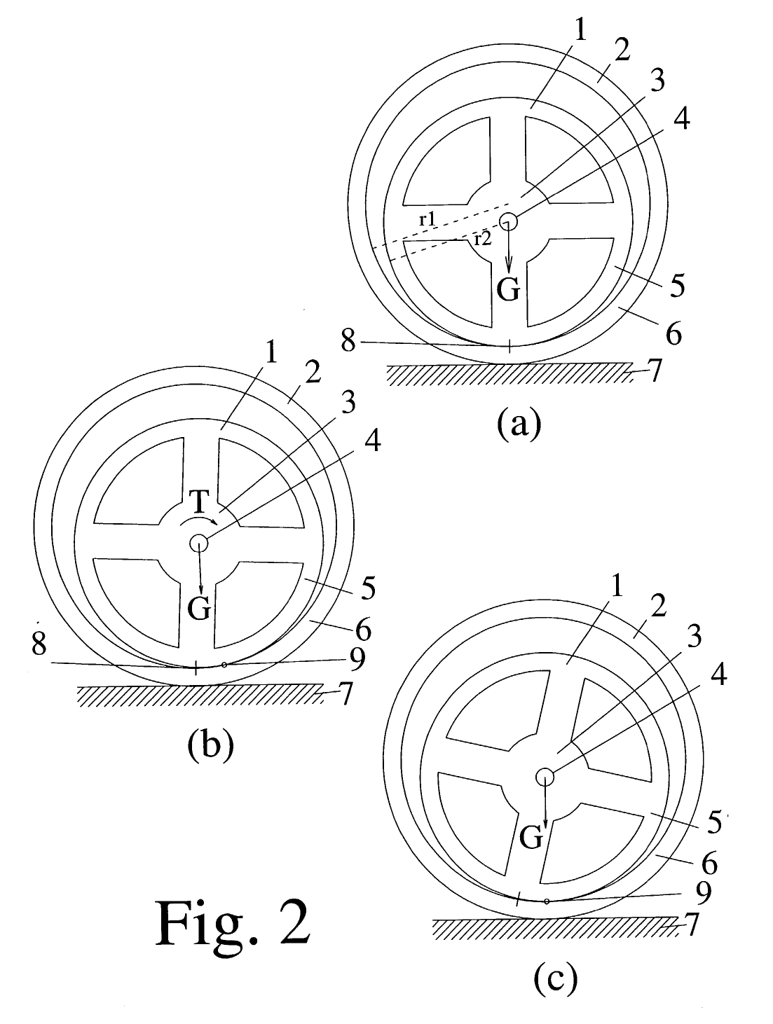

FIG. 2 is a simplified schematic representation of an exemplary embodiment of the compound wheel provided in the present invention, showing its kinematics during acceleration.

In this representation, the compound wheel comprises a driving inner wheel member (1) confined within a driven outer wheel member (2). The inner wheel member (1) has a hub (3) and a first rim which is the inner rim (5) of the compound wheel. The hub (3) is attached to and rotates around an axle (4). The outer wheel member has a second rim which is the outer rim (6) of the compound wheel, with the radius r1 of the circle representing the inner surface of the outer rim (6) being bigger than the radius r2 of the circle representing the outer surface of inner rim (5).

Because the center of gravity of the inner wheel member (1) lies generally within the axis of its axle (4), when the compound wheel rests on a horizontal planar surface (7) (FIG. 2A), the inner wheel member (1) tends to balance itself within the outer wheel member (2) so that the point(s) of contact (8) between the opposing surfaces of the two rims (5,6) lie(s) within a vertical plane comprising the axis of the axle (4) of the inner wheel member. The point(s) of contact (8) tend(s) to move closer to the horizontal planar surface (7) due to the effect of gravitational force G on the mass of the inner wheel member (1).

On forward acceleration of the compound wheel (FIG. 2B), by either torque T provided through the axle (4) of the inner wheel member or forward acceleration of the axle (4) (with the hub (3) substantially rigidly fixed to axle (4)), the inner wheel member (1) rolls forwardly on the curved inner surface of the outer rim (6), with forward shifting of the point(s) of contact (9) between the opposing surfaces of the two rims (5,6). Then, the gravitational force G related to the mass of the inner wheel member will tend to move the outer wheel member to a new position bringing the resulting point(s) of contact (9) closer to the horizontal planar surface (7) (FIG. 2C).

During acceleration, as the driving inner wheel member (1) rolls within the driven outer wheel member (2), the movement of the inner wheel member momentarily precedes the movement of the outer wheel member. Thus, two distinct sets of frictional forces exist: a first set of internal frictional forces between the opposing surfaces of the two rims (5,6); and a second set of external rolling frictional forces between the outer surface of the outer wheel member (2) and the horizontal planar surface (7). The portion of the provided accelerating force, whether in the form of torque T provided through the axle (4) of the inner wheel member or direct forward acceleration of its axle (4) expended in overcoming the resistance due to friction is believed to be consumed only in overcoming the internal frictional forces.

The forward shifting of the points of contact between the opposing surfaces of the rims (5,6) of the two wheel members in (FIG. 2B) leads to redistribution of the force on the contact area between the outer surface of the outer wheel member (2) and the horizontal planar surface (7). This results in lessening of the contact forces between the two surfaces at the rear end of the contact area and leads to reduction in the force needed for rotating the outer wheel member (2).

It should be appreciated that in operation, e.g., when supporting an actual wheeled conveyance, the total force due to gravity at the point(s) of contact between the opposing surfaces of the rims (5,6) includes not just force G due to the mass of the wheel member (1), but also some force due to the mass of the axle as well as some portion of the supported conveyance. Accordingly, only a small forward shift of the point(s) of contact between the opposing surfaces of the rims (5,6) of the two wheel members is generally needed to roll the outer wheel member (2).

The net force including the gravitational force G related to the mass of the wheel in addition to the portion of the load born by the wheel tends to maintain generally good contact between the outer surface of the outer wheel member (2) and the horizontal planar surface (7) during acceleration.

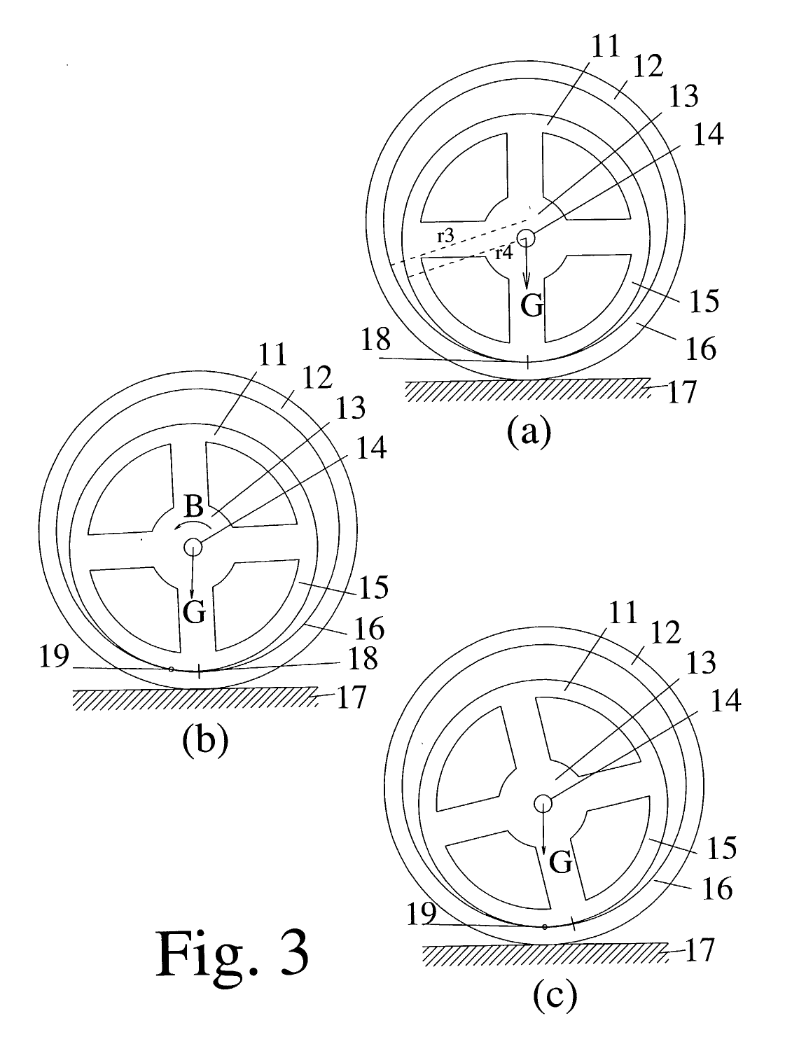

FIG. 3 is a simplified schematic representation of an exemplary embodiment of the compound wheel provided in the present invention, showing its kinematics during deceleration.

In this representation, the compound wheel comprises a driving inner wheel member (11) confined within a driven outer wheel member (12). The inner wheel member (11) has a hub (13) and a first rim which is the inner rim (15) of the compound wheel. The hub (13) is attached to and rotates around an axle (14). The outer wheel member has a second rim which is the outer rim (16) of the compound wheel, with the radius r3 of the circle representing the inner surface of the outer rim (16) being bigger than the radius r4 of the circle representing the outer surface of the inner rim (15).

Because the center of gravity of the inner wheel member (11) lies within the axis of its axle (14), at any position during steady forward movement of the wheel on a horizontal planar surface (17) (FIG. 3A), the inner wheel member (11) tends to balance itself within the outer wheel member (12) so that the point(s) of contact (18) between the opposing surfaces of the two rims (15,16) lie(s) within a vertical plane comprising the axis of the axle (14) of the inner wheel member. The point(s) of contact (18) tend(s) to move closer to the horizontal planar surface (17) due to the effect of gravitational force G related to the mass of the inner wheel member (11).

On decelerating, the compound wheel (FIG. 3B), by either braking Force B provided through the axle (14) of the inner wheel member or backward deceleration of its axle (14) (with the hub (13) substantially rigidly fixed to axle (14)), the inner wheel member (11) rolls backwardly on the curved inner surface of the outer rim (16), with backward shifting of the point(s) of contact (19) between the opposing surfaces of the two rims (15,16). Then, the gravitational force G related to the mass of the inner wheel member will move the outer wheel member to a new position bringing the resulting point(s) of contact (19) closer to the horizontal planar surface (17) (FIG. 3C), i.e., the deceleration of the driving inner wheel member (11) momentarily precedes the deceleration of the driven outer wheel member (12). As during acceleration, it should be appreciated that in operation, e.g., when supporting an actual wheeled conveyance, the total force due to gravity at the point(s) of contact between the opposing surfaces of the rims (15,16) includes not just force G related to the mass of the inner wheel member (11), but also some force due to the mass of the axle as well as some portion of the supported conveyance.

During deceleration, the net force including the gravitational force G related to the mass of the wheel in addition to the portion of the load born by the wheel tends to maintain generally good contact between the outer surface of the outer wheel member (12) and the horizontal planar surface (17).

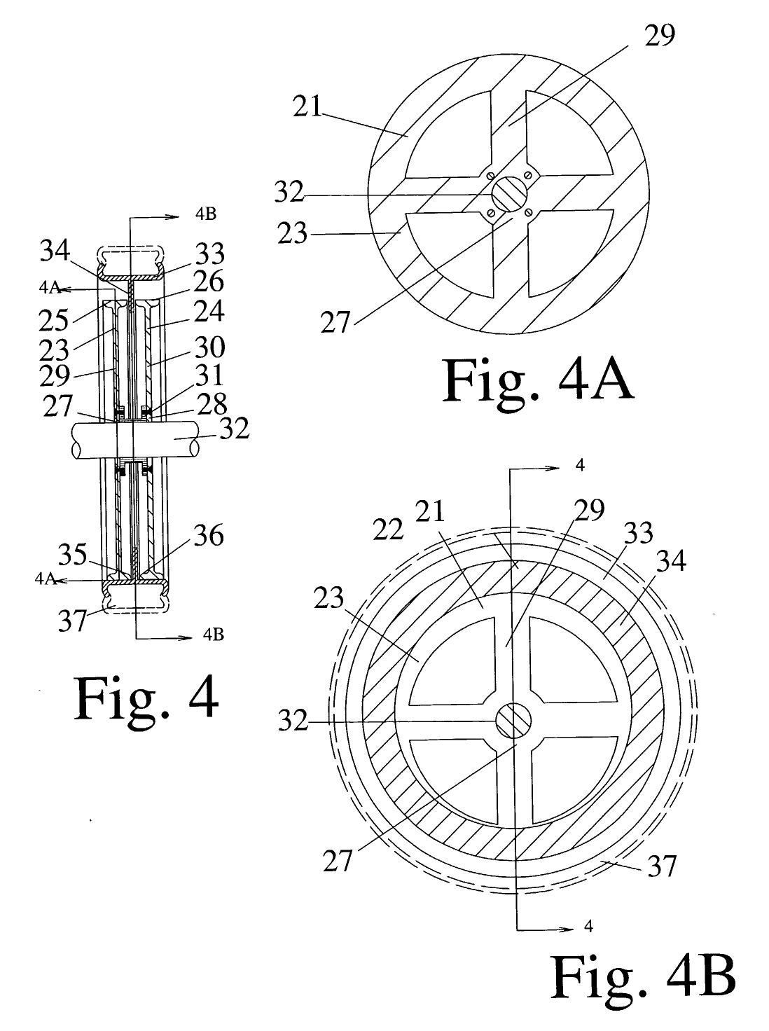

FIG. 4 is a cross sectional view of a schematic representation of an exemplary embodiment of a compound wheel in accordance with the present invention.

The main components of the compound wheel of this embodiment are an inner wheel member (21) confined within an outer wheel member (22). This embodiment is now considered with reference to FIG. 4A which is a cross sectional view, taken at the plane of line 4A-4A in FIG. 4, and FIG. 4B which is a generally cross sectional view, taken at the plane of line 4B-4B in FIG. 4. The inner wheel member (21) comprises two sub-wheels (23,24) each having a rim which together are the inner sub-rims (25,26) of the compound wheel, a hub (27,28), and a number of arms (29,30) joining the sub-rims to their respective hub. (Note that sub-wheel 23 and arm 29 depicted in FIG. 4B are not intersected by line 4B-4B in FIG. 4 but are shown as they would be viewed through the opening in outer wheel member (22).) The two sub-wheels (23,24) are attached to one another through a common hub (31), which also provides attachment to the shaft (32) around which the inner wheel member (21) rotates. The outer wheel member (22) comprises a second rim which is the outer rim (33) of the compound wheel and has a concentric rib (34) attached to its inner surface. (The region depicted (33) in FIG. 4B is an elevation of the out lip portion of outer rim (33) and not a cross section at the line 4B-4B in FIG. 4.) The concentric rib (34) fits within the recess formed between the opposing edges (35,36) of the sub-rims (25,26) of the sub-wheels (23,24) of the inner wheel member (21). An optional structure to provide a smoother ride and to maintain generally good contact between the compound wheel and the planar surface on which it rolls during operation, such as a tire (37), can be fixed to the outer surface of the outer rim (33). Also, it should be appreciated that sub-wheels (23,24) rather than comprising arms (29,30) could also each or either comprise a solid disk having no openings defining arms.

In operation, the concentric rib (34) and the opposing edges (35,36) of the sub-rims (25,26) of the sub-wheels (23,24) of the inner wheel member (21) are a means for preventing lateral displacement of the inner rim and the outer rim relative to one another. Thus, these structures prevent lateral displacement of the two wheel members (21,22) relative to one another, with the kinematics of the compound wheel of this embodiment being similar to that discussed herein before in the schematic representations of FIG. 2 & FIG. 3. On acceleration, the driving inner wheel member (21) rolls forwardly on the curved inner surface of the outer rim (33) of the outer wheel member (22), followed by forward rolling of the driven outer wheel member (22). On deceleration, the inner driving wheel member (21) rolls backwardly on the curved inner surface of the outer rim (33) of the outer wheel member (22), followed by backward rolling of the driven outer wheel member (22).

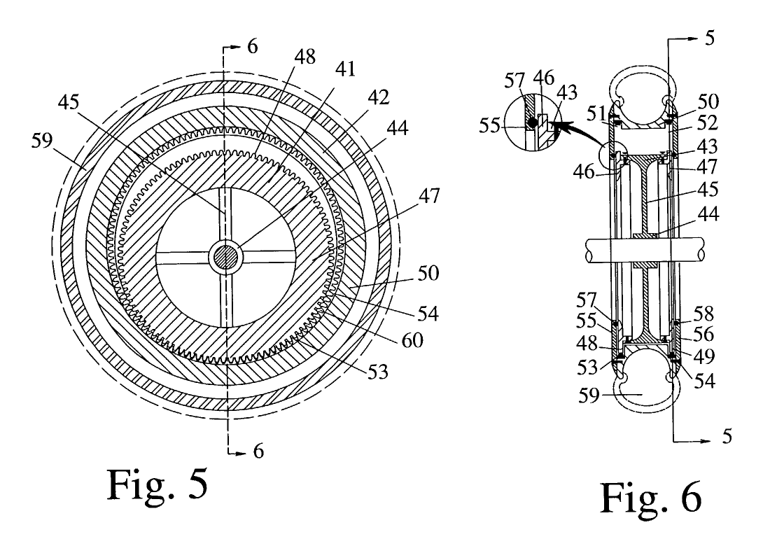

FIG. 5 is a generally cross sectional view of a schematic representation of another exemplary embodiment of a compound wheel in accordance with the present invention.

The main components of the compound wheel of this embodiment are an inner wheel member (41) confined within an outer wheel member (42). Further as shown in FIG. 6, which is a cross sectional view taken at the plane of line 6-6 in FIG. 5, the inner wheel member (41) comprises an inner rim (43), a hub (44), and a number of arms (45) joining the inner rim to the hub. (In FIG. 5, the arms (45) and hub (44) are shown as they would be viewed through the opening in outer wheel member (42) and are not intersected by the line 6-6 in FIG. 6.) Further, two circular flanges (46,47) are attached, each to one of the two lateral edges of the inner rim (43), with the outer edge of each flange (46,47) provided with inner sets of teeth (48,49). The outer wheel member (42) comprises an outer rim (50) having two lateral rounded recesses (51,52), with other sets of teeth (53,54) fixed within each of the lateral recesses (51,52). Two other circular flanges (55,56) are attached, each to one of the two lateral edges of the outer rim (50), with oil-sealing means (57,58), such as rubber 0-rings or metal rings, fixed within grooves on the inner surfaces of the flanges (55,56) of the outer wheel member. An optional structure to provide a smoother ride and to maintain generally good contact between the compound wheel and the planar surface on which it rolls during operation, such as a tire (59), may be fixed to the outer surface of the outer rim (50).

In operation, the flanges (46,47,55,56) of the two wheel members are a means for preventing lateral displacement of the inner rim and the outer rim relative to one another and thus prevent the lateral displacement of the two wheel members (41,42) relative to one another.

A lubricant may be provided in the space confined between the opposing surfaces of the two wheel members (60) to further decrease the operational frictional losses. The sets of teeth (48,53) & (49,54) are a means for preventing slipping of the opposing surfaces of the inner rim (43) and the outer rim (50) relative to one another during operation. Also, it should be appreciated that inner wheel member (41) rather than comprising arms (45) could also comprise a solid disk having no openings defining arms.

The kinematics of the compound wheel of this embodiment are similar to that discussed herein before in the schematic representations of FIG. 2 & FIG. 3. Accordingly, on acceleration, the driving inner wheel member (41) rolls forwardly on the curved inner surface of the outer rim (50) of the driven outer wheel member (42), followed by forward rolling of the outer wheel member (42). Similarly, on deceleration, the driving inner wheel member (41) rolls backwardly on the curved inner surface of the outer rim (50) of the outer wheel member (42), followed by backward rolling of the driven outer wheel member (42).

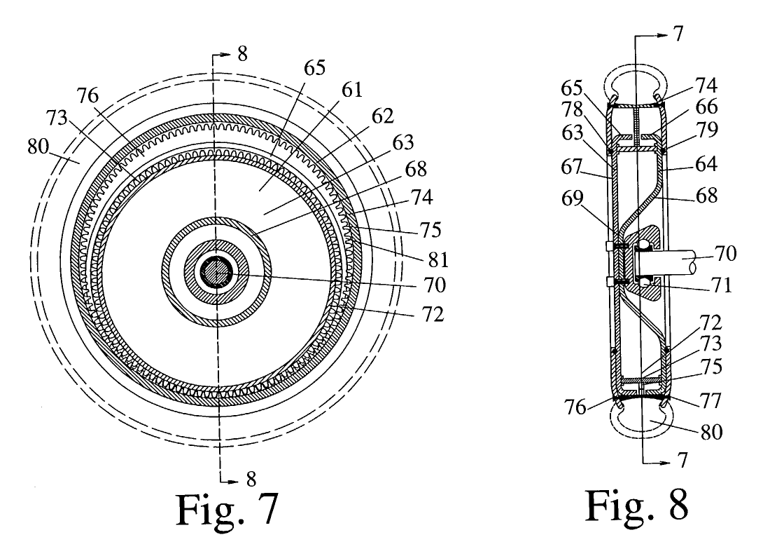

FIG. 7 is a generally cross sectional view of a schematic representation of yet another exemplary embodiment of a compound wheel in accordance with the present invention.

The main components of the compound wheel of this embodiment are an inner wheel member (61) confined within an outer wheel member (62). With reference to FIG. 8 which is a cross sectional view, taken at the plane of line 8-8 in FIG. 7, wheel member (61) comprises two sub-wheels (63,64) each having a sub-rim (65,66). The two-sub-rims together comprise an inner rim of the compound wheel. The first sub-wheel (63) has a disk shaped central part (67). The second sub-wheel (64) has a frustroconical shaped central part (68). Central parts (67) and (68) join centrally to form a common hub (69) providing attachment of the inner wheel member (61) to the shaft (70) around which it rotates through a bearing (71), e.g., a ball or journal bearing. A concentric cylinder (72) is fixed between the opposing inner surfaces of the central parts (67,68) of the two sub-wheels to which a set of teeth (73) is fixed. The outer wheel member (62) comprises a second rim which is the outer rim (74) of the compound wheel and has a set of teeth (75) fixed to its inner surface, with two circular flanges (76,77) attached, each to one of the two lateral edges of the outer rim (74). Oil-sealing means (78,79), such as rubber 0-rings or metal rings may be fixed within grooves on the inner surfaces of the flanges (76,77) of the outer wheel member. Optionally, a tire (80) may be fixed to the outer surface of the outer rim (74) to smooth the ride and maintain good contact between the compound wheel and the planar surface on which it rolls during operation.

In operation, the flanges (76,77) and the radially outer portions of the subwheels (63,64) are a means for preventing lateral displacement of the inner rim and the outer rim of the compound wheel relative to one another. This means prevents the lateral displacement of the two wheel members (61,62) relative to one another.

A lubricant may be provided in the space confined between the opposing surfaces of the two wheel members (81) to further decrease the operational frictional losses. The sets of teeth (73,75) are a means for preventing the slipping of the opposing surfaces of the sub-rims (65,66) and the outer cylindrical rim (74) relative to one another during operation.

The kinematics of the compound wheel of this embodiment are similar to that discussed herein before in the schematic representations of FIG. 2 & FIG. 3. Accordingly, on acceleration, the driving inner wheel member (61) rolls forwardly on the curved inner surface of the outer rim (74) of the outer wheel member (62), followed by forward rolling of the driven outer wheel member (62). On deceleration, the driving inner wheel member (61) rolls backwardly on the curved inner surface of the outer rim (74) of the outer wheel member (62), followed by backward rolling of the driven outer wheel member (62).

In the present invention, the wheel within a wheel arrangement is designed to take advantage of the partial dynamic offsetting of the center of mass of the inner wheel and the effective load bearing point of the conveyance within each wheel from a vertical line coincident with the contact point of the outer wheel with the generally planar surface upon which the wheel rolls. In certain embodiments of the present invention, the inner wheel member may be disposed with teeth and the outer wheel member may be disposed with corresponding teeth. Unlike prior art internal gear arrangements, in the claimed compound wheel both the inner wheel member and the outer wheel member are capable of turning and the outer wheel member is shaftless and hubless, and the wheel members are disposed with means to prevent lateral displacement of the two wheel members relative to one another.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

Further, in this description of the invention, it should be appreciated that references to “driving” and “driven” wheel members are used for purposes of illustration and are not intended to limit the invention to motorized wheeled conveyances. Those of ordinary skill in the art will appreciate that the compound wheel described herein may also be used in non-motorized conveyances, e.g., non-powered rail cars, and remain within the scope of the invention.

That which is claimed:

1. A compound wheel comprising:
an inner wheel member having a hub attached to an inner rim;
an outer wheel member having an outer rim, the inner wheel member being confined within the outer wheel member; and
means for preventing lateral displacement of the inner rim and the outer rim relative to one another.

2. The compound wheel of claim 1 wherein the outer rim has two lateral edges and the means for preventing lateral displacement of the inner rim and the outer rim relative to one another comprises two lateral flanges, each attached to one of the edges of the outer rim.

3. The compound wheel of claim 1 wherein the inner rim has an outer surface and the outer rim has an inner surface and the means for preventing lateral displacement of the inner rim and the outer rim relative to one another comprises at least one concentric rib fixed to the inner surface of the outer rim, and the outer surface of the inner rim having a recessed portion shaped to receive the concentric rib.

4. The compound wheel of claim 1 wherein a lubricant is provided in the space confined between the opposing surfaces of the inner rim and the outer rim.

5. The compound wheel of claim 1 wherein the inner rim has an outer surface and the outer rim has an inner surface, the wheel further comprising means for preventing relative slipping of the outer surface of the inner rim and the inner surface of the outer rim relative to one another.

6. The compound wheel of claim 5 wherein the means for preventing slipping of the outer surface of the inner rim and the inner surface of the outer rim relative to one another comprises sets of teeth fixed to the inner wheel member and the outer wheel member.

7. A compound wheel comprising:
an inner wheel member comprising at least two sub-wheels, each sub-wheel having a hub attached to a sub-rim;
an outer wheel member having an outer rim, the inner wheel member being confined within the outer wheel member; and
means for preventing lateral displacement of the sub-rims and the outer rim relative to one another.

8. The compound wheel of claim 7 wherein the outer rim has two lateral edges and the means for preventing lateral displacement of the sub-rims and the outer rim relative to one another comprises two lateral flanges, each attached to one of the edges of the outer rim.

9. The compound wheel of claim 7 wherein the sub-rims have outer surfaces and the outer rim has an inner surface and the means for preventing lateral displacement of the sub-rims and the outer rim relative to one another comprises at least one concentric rib fixed to the inner surface of the outer rim, and an annular opening formed between the outer surfaces of the sub-rims to receive the concentric rib.

10. The compound wheel of claim 7 wherein a lubricant is provided in the space confined between the opposing surfaces of the sub-rims and the outer rim.

11. The compound wheel of claim 7 wherein the sub-rims have outer surfaces and the outer rim has an inner surface, the wheel further comprising means for preventing relative slipping of the outer surfaces of the sub-rims and the inner surface of the outer rim relative to one another.

12. The compound wheel of claim 11 wherein the means for preventing slipping of the outer surfaces of the sub-rims and the inner surface of the outer rim relative to one another comprises sets of teeth fixed to the inner wheel member and sets of teeth fixed to the outer wheel member.

13. A compound wheel comprising:
an inner wheel member comprising an inner rim, a hub, a plurality of arms joining the inner rim to the hub, and annular flanges each attached to one of the two lateral edges of the inner rim, the outer edge of each flange being provided with teeth; and
an outer wheel member having an outer rim having two lateral rounded recesses, teeth fixed within each of the lateral recesses, the inner wheel member being confined within the outer wheel member, with two annular flanges each attached to one of the two lateral edges of the outer rim.

14. The compound wheel of claim 13 wherein a lubricant is provided between the opposing surfaces of the inner rim and the outer rim.

15. A compound wheel comprising:
an inner wheel member having two sub-wheels each having a sub-rim, the first sub-wheel having a disk shaped central portion, the second sub-wheel having a frustroconical shaped central portion, the central portions of the two sub-wheels joining centrally to form a common hub for attachment of the inner wheel member to a shaft, a concentric cylinder fixed between the opposing inner surfaces of the central parts of the two sub-wheels, the cylinder having a set of teeth fixed to its outer surface; and
an outer wheel member having an outer rim having a set of teeth fixed to its inner surface, the inner wheel member being confined within the outer wheel member, with two circular flanges each attached to one of the two lateral edges of the outer rim.

16. The compound wheel of claim 15 wherein a lubricant is provided in the space confined between the opposing surfaces of the sub-rims and the outer rim.
